(19) United States
(12) Patent Application Publication
(10) Pub. No.: US 2025/0079758 A1
(43) Pub. Date: Mar. 6, 2025

(54) CONNECTOR AND CONNECTOR ASSEMBLY

(71) Applicant: Molex, LLC, Lisle, IL (US)

(72) Inventor: Makiko Ikeda, Yamato (JP)

(21) Appl. No.: 18/779,117

(22) Filed: Jul. 22, 2024

(30) Foreign Application Priority Data
Aug. 30, 2023 (JP) 2023-139641

(51) Int. Cl. H01R 13/627; H01R 12/72

(52) U.S. Cl. CPC H01R 13/6273; H01R 12/722

(57) ABSTRACT

The elastic locking part has a rear connecting part connected to the housing body, a front connecting part connected to the housing body, and a beam part connecting the rear connecting part and the front connecting part. The beam part has a front elastic part in which an engaging part is formed, and a rear elastic part. The rear elastic part has a first extending part, a first curved part, and a second extending part. The first extending part extends from the front part of the first curved part in a direction away from the housing body, and the second extending part extends from the rear part of the first curved part in a direction away from the housing body.

### TECHNICAL FIELD

The present disclosure relates to a connector and a connector assembly.

Patent document 1 describes a connector having an elastically deformable lock arm connected to an upper surface of a housing body. The lock arm is formed with a locking protrusion and a lock releasing part. The locking protrusion hooks onto a locking part formed on a mating connector, restricting separation of the two connectors. An operator can press the lock releasing part to release the engagement between the locking protrusion and the mating connector, thereby separating the two connectors.

### BACKGROUND

Prior Art Documents; Patent Documents; Patent Document 1: Japanese Unexamined Patent Application Publication H7-220807

### SUMMARY

With the structure of Patent Document 1, the force required for elastic deformation of the lock arm, or in other words, the force required for separating the two connectors, may be large. This affects the operability of the operation of separating the two connectors.

The connector proposed in the present disclosure is a connector that has a housing, and can be mated with the mating connector from the front side. The housing has a housing body that stores terminals, and an elastic locking part connected to the housing body and for engaging with the mating connector. The elastic locking part has a rear connecting part connected to the housing body, a front connecting part connected to the housing body, and a beam part connected to the rear connecting part and the front connecting part. The beam part has a front elastic part having an engaging part formed therein for engaging with the mating connector, and a rear elastic part formed rearward of the front elastic part, where the front elastic part and the rear elastic part are elastically deformable such that the engaging part moves toward the housing body. The rear elastic part has a first extending part, a first curved part, and a second extending part. The first extending part extends from a front part of the first curved part in a direction away from the housing body, and the second extending part extends from a rear part of the first curved part in a direction away from the housing body. A plurality of terminals are not necessarily elements of this connector.

With this connector, the force required to deform the beam part can be reduced, and the two connectors can be separated more smoothly.

In an embodiment of the connector, the rear connecting part extends from a first end part of the rear connecting part connected to the housing body in a direction away from the housing body; and the rear elastic part has a second curved part that connects a second end part of the rear connecting part and a second end part of the second extending part.

In an embodiment of the connector, the rear connecting part is located rearward of the first extending part, the first curved part, and the second extending part.

In an embodiment of the connector, the beam part has an operating part located between the front elastic part and the rear elastic part.

In an embodiment of the connector, the elastic locking part has a contact part that contacts with an outer surface of the housing body when the engaging part moves toward the housing body; and a distance between the contact part and the outer surface of the housing body may be smaller than a distance between the first curved part and the outer surface of the housing body.

In an embodiment of the connector, the outer surface of the housing body has a first portion facing the contact part, and a second portion facing the first curved part, and the first portion may bulge toward the contact part more than the second portion.

In an embodiment of the connector, the contact part may protrude from the operating part toward the outer surface of the housing body.

In an embodiment of the connector, the beam part may be located outside in the left-right direction with regard to the side surface of the housing body.

In an embodiment of the connector, the beam part may be located on an outer side in a left-right direction with regard to a side surface of the housing body; and the contact part of the elastic locking part may contact a side surface of the housing body when the engaging part moves toward the housing body.

A connector assembly proposed in the present disclosure includes the connector and a mating connector.

### BRIEF DESCRIPTION OF THE DRAWINGS

FIG. 1 is a perspective view depicting a connector assembly proposed by the present disclosure. In this figure, a connector and a mating connector are assembled together.

FIG. 2 is an exploded perspective view depicting connector proposed in the present disclosure and the upper side of the mating connector.

FIG. 3 is an exploded perspective view depicting connector proposed in the present disclosure and the lower side of the mating connector.

FIG. 4 is a perspective view depicting the connector proposed by the present disclosure.

FIG. 5A is a plan view of a right part of the housing of the connector proposed in the present disclosure.

FIG. 5B is a plan view depicting the same portion as FIG. 5A. In this figure, the elastic locking part is depicted after elastic deformation.

FIG. 6 is a perspective view of a mating connector.

FIG. 7 is a front view of the connector assembly proposed in the present disclosure.

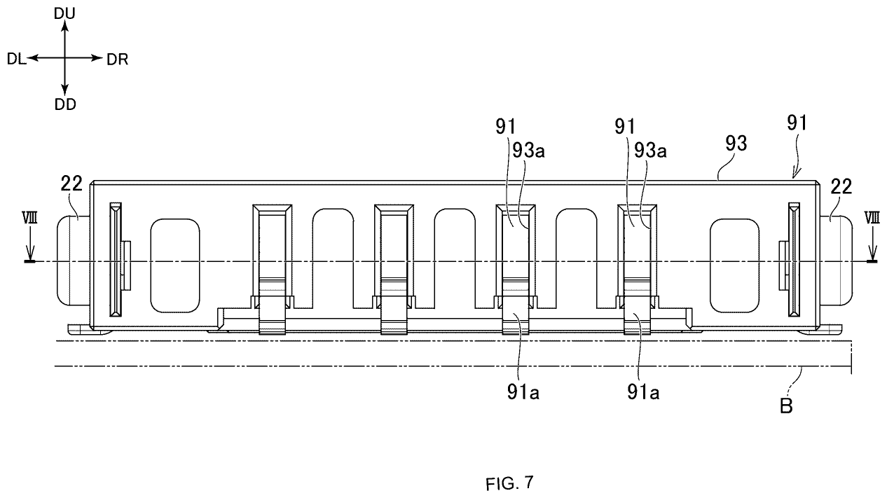

FIG. 8A is a cross-sectional view obtained on the line VIII-VIII as illustrated in FIG. 7.

FIG. 8B is an enlarged view of the right part of FIG. 8A.

FIG. 9 is a plan view depicting a modified example of the connector proposed in the present disclosure.

FIG. 10 is a plan view depicting another modified example of the connector proposed in the present disclosure.

### DETAILED DESCRIPTION

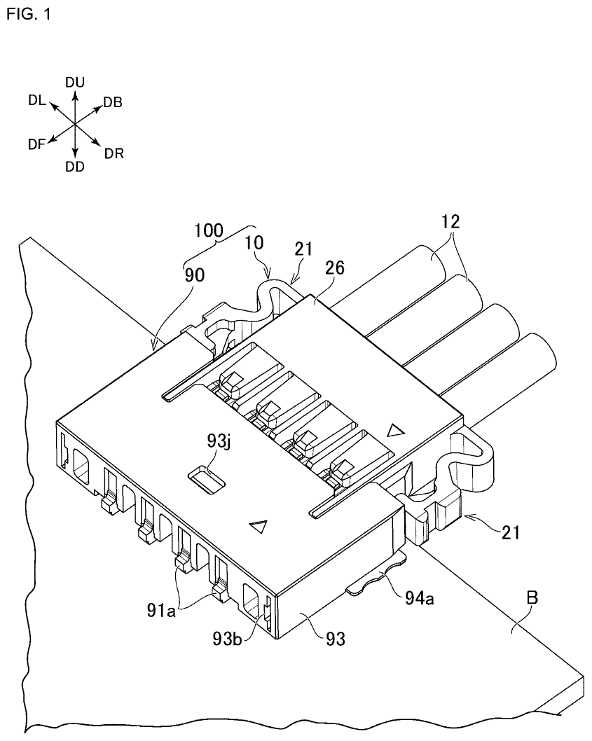

The connector assembly proposed in the present disclosure is described below. In the present specification, the directions indicated by DU and DD in FIG. 1 are referred to as upper and lower, respectively, the directions indicated by DF and DB in FIG. 1 are referred to as front and rear, respectively, and the directions indicated by DR and DL in FIG. 1 are referred to as right and left, respectively. These directions are used to describe the relative position of elements (parts, members, sites) of the connector and connector assembly. These directions do not limit the orientation of the connector or the connector assembly.

As depicted in FIG. 1, a connector assembly 100 includes a mating connector 90 and a connector 10 that can be mated with the mating connector 90. The mating connector 90 is located in front of the connector 10 and can be mated with the connector 10 from the front side of the connector 10. The mating connector 90 may be, for example, a connector mounted on a circuit board B as depicted in the figure. The connector 10 may be, for example, a connector provided at an end part of a plurality of cables 12. In other words, the connector assembly 100 may be a connector assembly that electrically connects the cables 12 and the circuit board B, for example.

Contrary to the example depicted in FIG. 1, the mating connector 90 may be provided at the end part of the plurality of cables, and the connector 10 may be a connector for mounting on the circuit board B. As yet another example, the mating connector 90 may be, for example, a connector provided at an end part of a plurality of mating cables. In other words, the connector 10 and mating connector 90 may be provided at the end of the cables 12 and the ends of the mating cables, respectively. Furthermore, the connector assembly 100 may be a connector assembly that electrically connects the cable 12 to the mating cable.

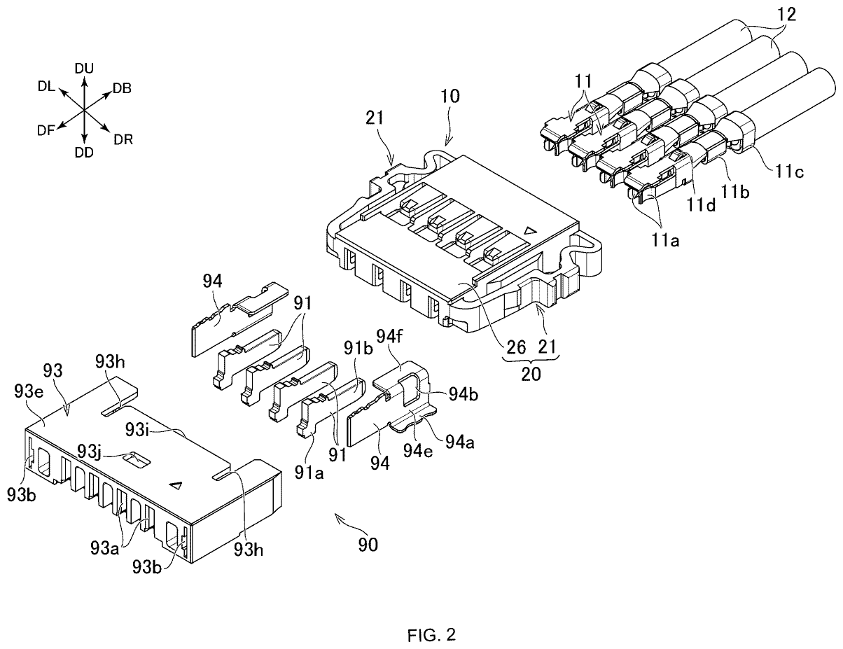

As depicted in FIG. 2, the mating connector 90 has a plurality of terminals 91 arranged in the left-right direction, and a housing 93 that holds these terminals 91. Furthermore, the mating connector 90 may have two reinforcing metal fittings 94 that are provided to the outside of the plurality of terminals 91 in the left-right direction.

The terminal 91 may be in the form of a plate. As depicted in FIG. 2, the terminal 91 may have a connecting part 91a at the lower end of the rearmost part thereof, for connecting to the circuit board B. The connecting part 91a may be attached to a conductor pad on the circuit board B by soldering, for example. The terminal 91 may have a contact part 91b at a front part for contacting the terminal 11 of the connector 10. The terminals 91 may be formed by stamping from a metal plate.

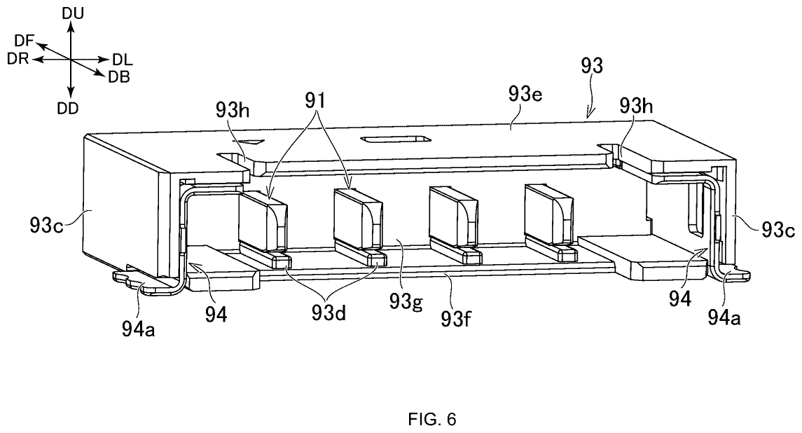

The plurality of terminals 91 may be held by a housing 93. As depicted in FIG. 2, the housing 93 is formed with a plurality of retaining holes 93a penetrating through in the front-back direction. The housing 93 has a front wall 93g (see FIG. 6). The retaining holes 93a may be formed in, for example, the front wall 93a. The plurality of terminals 91 are inserted into the respective retaining holes 93a and held therein. The housing 93 is made of resin.

The two reinforcing metal fittings 94 may be disposed on the right and left sides, respectively, of the plurality of terminals 91. As depicted in FIG. 2, the housing 93 is formed with a retaining hole 93b. The two reinforcing metal fittings 94 are inserted into the respective retaining holes 93b and are retained within the retaining holes 93b. The reinforcing metal fitting 94 has a mounting part 94a at a lower edge, which is attached to the circuit board B by soldering. The mounting part 94a may be bent outward in the left-right direction.

As depicted in FIG. 6, a plurality of protruding parts 93d extending in the front-back direction may be formed on the inner surface of the housing 93 (surface facing the outer surface of the connector 10 stored in the housing 93). The protruding part 93d may be formed, for example, on an upper wall 93e, a lower wall 93f, or an inner surface (upper surface) of the lower wall 93f among the left and right side walls 93c of the housing 93. The protruding part 93d may extend from a front wall 93g of the housing 93 to near the center of the space in the housing 93 in which the connector 10 is disposed. The plurality of protruding parts 93d may be aligned in the left-right direction. The terminals 91 held in the housing 93 may be located above the protruding parts 93d.

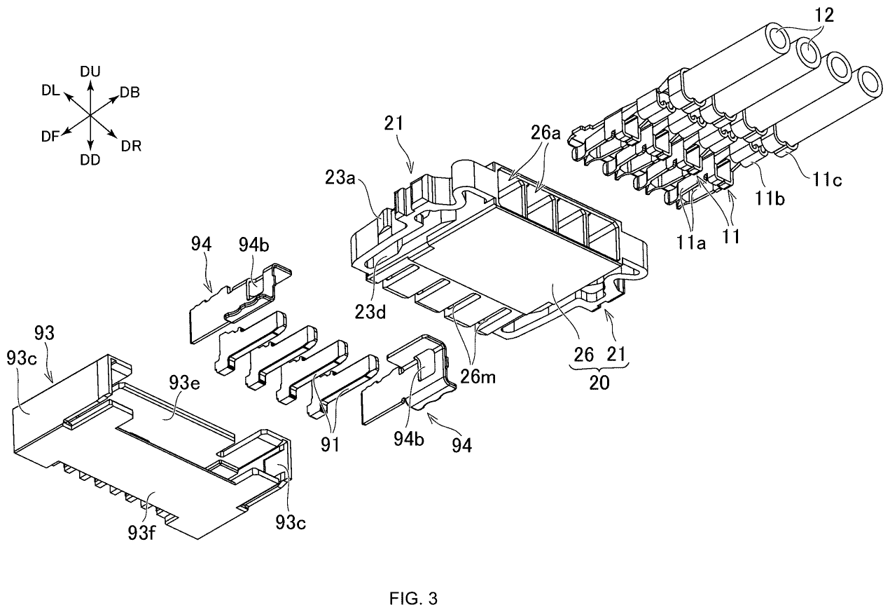

Furthermore, a groove 26m (see FIG. 3) extending in the front-back direction may be formed on the lower surface of the housing body 26 of the connector 10. During the process of inserting the connector 10 into the mating connector 90, the groove 26m of the connector 10 may move forward along the protruding part 93d of the mating connector 90 (see FIG. 6). Therefore, the connector 10 is guided to the correct position relative to the mating connector 90, without inclining during insertion. Therefore, the connector 10 and the mating connector 90 can be prevented from unintentionally colliding with each other.

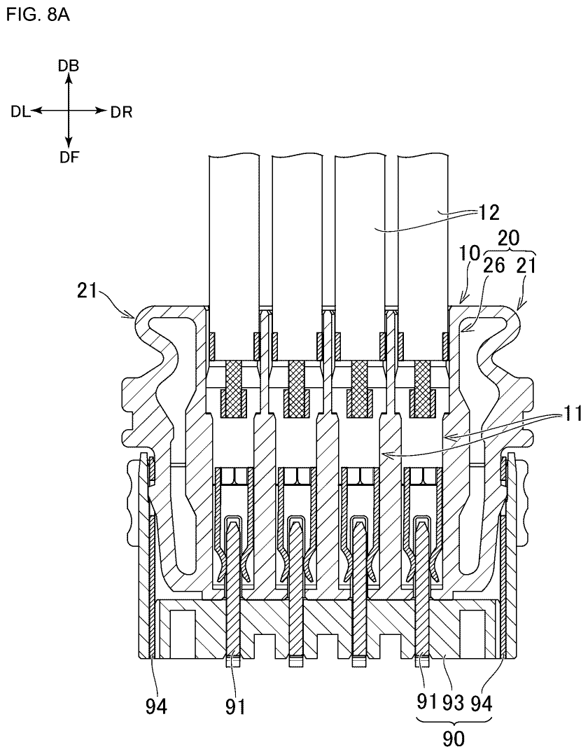

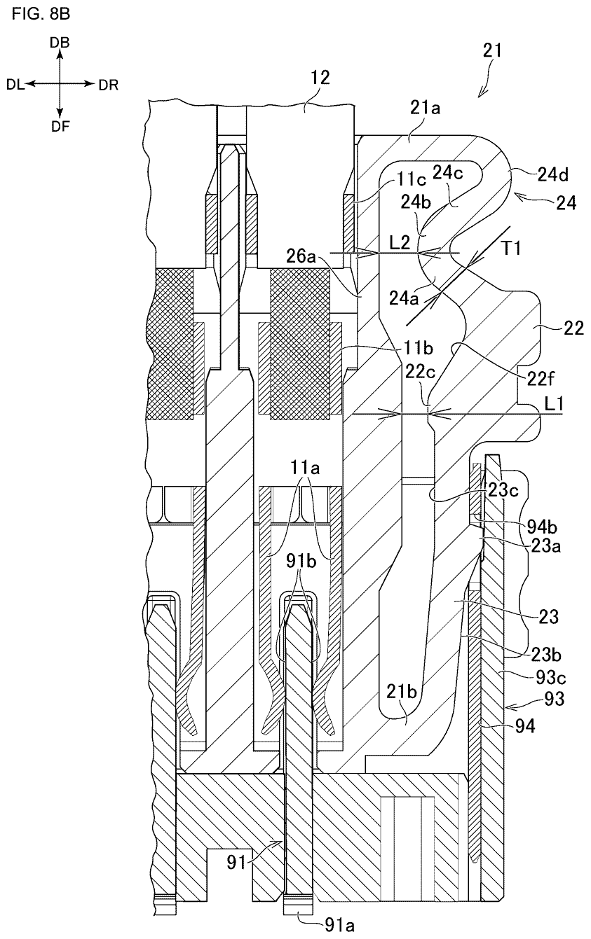

As depicted in FIG. 2, the reinforcing metal fitting 94 may have an engaged part 94b. The engaged part 94b may be, for example, a hole that passes through the plate-shaped reinforcing metal fitting 94 in the left-right direction. The engaging part 23a (see FIG. 8B) of the housing 20 of the connector 10 engages with the engaged part 94b, thereby restricting separation of the connector 10 and the mating connector 90. The engaged part 94b does not have to be a hole, so long as the engaged part has a structure that allows the engaging part 23a to engage.

As depicted in FIG. 2, the engaged part 94b is separated above the mounting part 94a, and the reinforcing metal fitting 94 may have a wall part 94e between the mounting part 94a and the lower edge of the engaged part 94b. As described above, the reinforcing metal fitting 94 has a mounting part 94a on the lower edge that is attached to the circuit board B by soldering. The wall part 94e enables an increase in the area of the portion to be soldered, and thus the strength of attachment to the circuit board B can be enhanced. In other words, the engaged part 94b does not extend to the mounting part 94a, so a decrease in mounting strength caused by the formation of the engaged part 94b can be suppressed. The engaged part 94b may be formed of a different member from the reinforcing metal fitting 94. For example, the engaged part 94b may be formed on the housing 93.

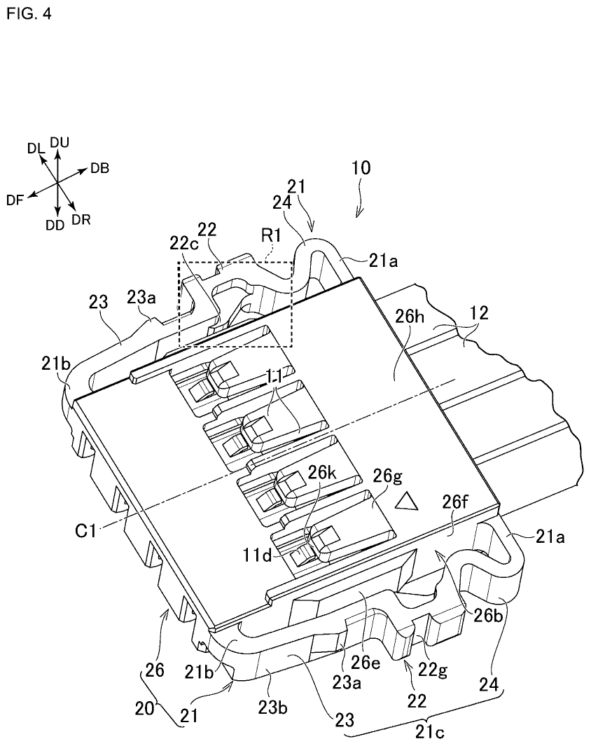

As depicted in FIG. 4, the connector 10 is formed with an elastic locking part 21, which will be described below in detail. The engaging part 23a is formed on the elastic locking part 21. In order to avoid interference with the wall part 94e of the reinforcing metal fitting 94, a notch 23d (see FIG. 3) formed below the engaging part 23a is formed on the elastic locking part 21. Thereby, the height of the connector assembly 100 can be reduced while maintaining the locking force between the engaging part 23a and the engaged part 94b.

As depicted in FIG. 2, the reinforcing metal fitting 94 may have an upper plate part 94f that extends toward the center of the mating connector 90 in the left-right direction on the upper edge. The upper plate part 94f can increase the strength of the reinforcing metal fitting 94 (particularly the strength of the portion around the engaged part 94b).

As depicted in FIG. 2, the connector 10 has a housing 20. The housing 20 has a housing body 26 that stores a plurality of terminals 11 arranged in the left-right direction. The housing body 26 may be formed, for example, in a substantially rectangular solid shape. The terminal 11 may be, for example, a terminal attached to the end part of the cable 12. A retaining hole 26a (see FIG. 3) extending in the front-back direction may be formed in the housing body 26. The terminal 11 may be inserted into the retaining hole 26a and retained therein.

The terminal 11 may have two contact parts 11a at the front part, which face each other in the left-right direction. The contact part 91b of the terminal 91 of the mating connector 90 is inserted between the two contact parts 11a. The two contact parts 11a are in the form of leaf springs, and are electrically connected by being pressed against the side surfaces of the contact part 91b by elastic force.

As depicted in FIG. 2, terminal 11 may have a barrel at the rear part. In other words, the terminal 11 may have, as a barrel, a cable retaining part 11c that holds the outer sheath of the cable 12, and a crimping part 11b that holds the electric wire (core wire) of the cable 12 and electrically connects thereto.

Furthermore, as depicted in FIG. 2, the terminal 11 may have a retained part 11d. The retained part 11d is formed on the upper surface of the terminal 11, for example. The retaining hole 26a may be formed with a retaining part 26g (see FIG. 4) that hooks onto the retained part 11d and restricts the terminal 11 from detaching (backward movement of the terminal 11). As depicted in FIG. 4, the retaining part 26g may be in the form of a leaf spring exposed at the upper surface 26h of the housing body 26. Furthermore, the tip end 26k (see FIG. 4) of the retaining part 26g may hook onto the retained part 11d.

As depicted in FIG. 2, a guide protruding part 26n extending in the front-back direction may be formed on the upper surface of the housing body 26. On the other hand, a guide groove 93h that similarly extends in the front-back direction may be formed on an upper wall 93e of the housing 93 of the mating connector 90. In the example depicted in the figure, two guide protruding parts 26n and two guide grooves 93h are formed, spaced apart in the left-right direction. In the process of inserting the connector 10 into the mating connector 90, the guide protruding parts 26n fit into the guide groove 93h, and move forward along the guide grooves 93h. Thereby the connector 10 and the mating connector 90 can be prevented from abutting each other in unintended areas.

Furthermore, as depicted in FIG. 2, a recess part 93i may be formed on an edge of the upper wall 93e of the housing 93. The recess part 93i is formed between the left and right guide grooves 93h. In the process of inserting the connector 10 into the mating connector 90, the two guide protruding parts 26n separated in the left-right direction are first placed in the recess part 93i, and then fitted into the aforementioned guide grooves 93h.

Note that, contrary to the example depicted in the figure, guide protruding parts may be formed on the inner surface of the housing 93, and guide grooves may be formed on the upper surface of the housing body 26.

As depicted in FIG. 2, a hole 93j may be formed in an upper wall 93e of the housing 93, passing through the upper wall in a vertical direction. When an operator inserts the connector 10 into the mating connector 90, the operator can visually confirm the passage of the front edge of the housing body 26 through this hole 93j. In other words, the hole 93j can function as an engagement detecting window.

As depicted in FIG. 4, the housing 20 has an elastic locking part 21 for engaging with a mating connector 90. The two elastic locking parts 21 are connected to the right part and left part of the housing body 26, respectively.

The elastic locking part 21 may be a site that is integrally molded of resin together with the housing body 26. In other words, heated and molten resin may be supplied to a mold corresponding to the shape of the housing 20 including the elastic locking part 21 and the housing body 26, and the resin may be cooled and solidified to form the housing 20. In the connector proposed in the present disclosure, the elastic locking part 21 and the housing body 26 are not members that are molded separately and attached together after molding.

As depicted in FIG. 4, the elastic locking part 21 may have a rear connecting part 21a at the rear end, that is connected to the housing body 26. Furthermore, the elastic locking part 21 may have a front connecting part 21b at the front end, which is connected to the housing body 26. The rear connecting part 21a and the front connecting part 21b may be connected to a side surface 26b of the housing body 26.

As depicted in FIG. 4, the elastic locking part 21 has a beam part 21c that is connected to the rear connecting part 21a and the front connecting part 21b. The beam part 21c may be located on the outer side of the side surface 26b of the housing body 26 in the left-right direction. In other words, the beam part 21c of the right elastic locking part 21 may be located to the right of the right side surface 26b, and the beam part 21c on the left side may be located to the left of the left side surface 26b.

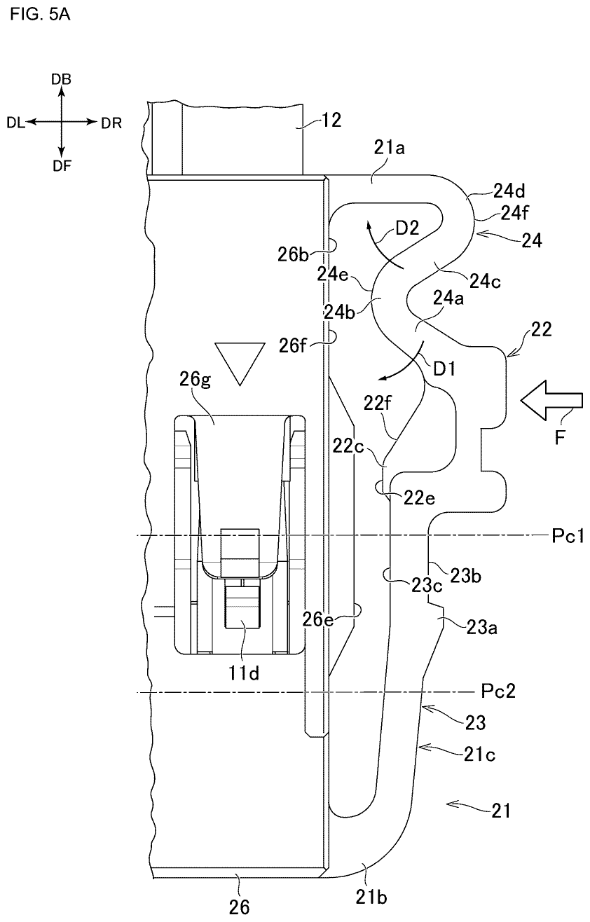

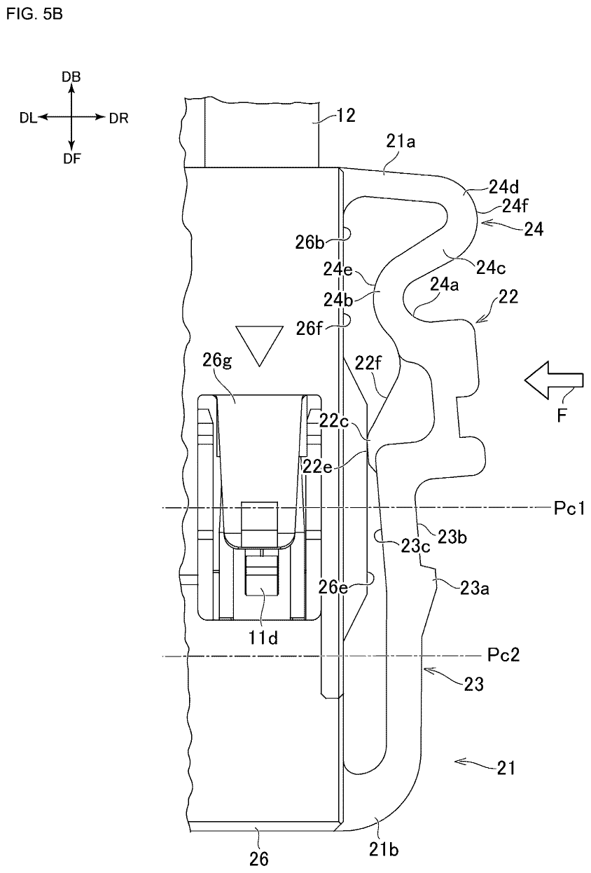

As depicted in FIG. 4, the beam part 21c has a front elastic part 23 formed at the front part thereof, and a rear elastic part 24 formed rearward of the front elastic part 23. The aforementioned engaging part 23a is formed on the front elastic part 23 for engaging with the mating connector 90. The elastic parts 23, 24 are elastically deformable so that the engaging part 23a moves relative to the housing body 26, or in other words, so that the engaging part 23a moves toward the center C1 of the housing 20 in the left-right direction (see FIGS. 5A and 5B).

The beam part 21c may have an operating part 22 at a midpoint of the beam part 21c that an operator presses toward the center of the housing 20 in the left-right direction. The front elastic part 23 extends from the operating part 22 toward the front connecting part 21b. The rear elastic part 24 extends from the operating part 22 toward the rear connecting part 21a. As depicted in FIGS. 5A and 5B, the front elastic part 23 and the rear elastic part 24 are elastically deformable such that the operating part 22 and the engaging part 23a move in the left-right direction. In other words, the front elastic part 23 and the rear elastic part 24 are elastically deformable such that the operating part 22 and the engaging part 23a approach the side surface (outer surface) 26b of the housing body 26.

The operating part 22 protrudes outward in the left-right direction beyond the front elastic part 23. As depicted in FIG. 8B, when the connector 10 is mated with a mating connector 90, the front elastic part 23 is stored inside a housing 93 of the mating connector 90. On the other hand, the operating part 22 is not stored in the housing 93, is located rearward of the side wall 93c of the housing 93, and protrudes outward in the left-right direction beyond the side wall 93c. The elastic locking part 21 is provided on the right part and left part of the housing 20, respectively. Therefore, when the connector 10 and the mating connector 90 are mated, the operator can pinch the operating parts 22 of the left and right elastic locking parts 21 with their fingers to elastically deform the elastic locking parts 21. Note that unlike the example depicted in FIG. 8B, the operating part 22 does not have to protrude outward in the left-right direction beyond the side wall 93c of the mating connector 90. The position of the operating part 22 is not particularly limited so long as the operating part 22 and the engaging part 23a are elastically deformable in a direction approaching the side surface (outer surface) 26b of the housing body 26.

The side surface of the operating part 22 may be formed with protruding parts and recesses. For example, as depicted in FIG. 4, a recess part 22g may be formed on the side surface of the operating part 22. Thereby, the fingers of the operator can more easily catch on the operating part 22, and thus the operator can smoothly press the operating part 22 to separate the connector 10 from the mating connector 90.

As depicted in FIG. 4, the engaging part 23a for engaging with an engaged part 94b (see FIG. 2 and FIG. 8B) of the mating connector 90 is formed on the front elastic part 23. The engaging part 23a is formed on a side surface 23b (surface facing outward in the left-right direction) of the front elastic part 23. The engaging part 23a may be a protruding part that protrudes outward in the left-right direction from the side surface 23b. As described above, when the connectors 10, 90 are mated together, the engaging part 23a fits into the engaged part 94b, which is a hole formed in the reinforcing metal fitting 94 (see FIG. 8B), thereby restricting separation of the connector 10 and the mating connector 90.

Unlike the example depicted in the figure, a protruding part is formed as the engaged part 94b in the reinforcing metal fitting 94, and the front elastic part 23 may have a recessed part formed as the engaging part 23a.

As depicted in FIG. 5A, the rear elastic part 24 may have a first extending part 24a, a first curved part 24b, and a second extending part 24c.

As depicted in FIG. 5A, the first extending part 24a extends from the front part of the first curved part 24b in a direction away from the housing body 24, or in other words, toward the outside in the left-right direction. An end part (outer side end part in the left-right direction) of the first extending part 24a is connected to the operating part 22. The second extending part 24c extends from the rear part of the first curved part 24b in a direction away from the housing body 24, or in other words, outward in the left-right direction. The end part (outer side end part in the left-right direction) of the second extending part 24c is connected to the rear connecting part 21a.

The first extending part 24a and the second extending part 24c may extend obliquely. In other words, the first extending part 24a may extend obliquely from the front part of the first curved part 24b toward the front and outside in the left-right direction. The second extending part 24c may extend obliquely rearward and outward in the left-right direction from the rear part of the first curved part 24b. Unlike the example depicted in the figure, the extending direction of the first extending part 24a and the second extending part 24b may be parallel to the left-right direction. The first extending part 24a may extend linearly or may be curved.

The first extending part 24a, the first curved part 24b, and the second extending part 24c may be connected to each other as described above to form an essentially U-shape that opens outward in the left-right direction. The first curved part 24b corresponds to a U-shaped curved part, and is located inside the first extending part 24a and the second extending part 24c in the left-right direction. The first curved part 24b may be curved in an arc shape. Furthermore, the first curved part 24b may be bent at the center of the first curved part 24b. In other words, the first extending part 24a, the first curved part 24b, and the second extending part 24c may be generally V-shaped and overall open outward in the left-right direction. The first curved part 24b preferably has a smooth curve in order to allow the first extending part 24a, the first curved part 24b, and the second extending part 24c to be flexibly and elastically deformed.

The rear elastic part 24 has the first curved part 24b in this manner, so the rear elastic part 24 can be lengthened while preventing the size of the connector 10 from increasing. As a result, the operating force F required to displace the operating part 22 (see FIGS. 5A and 5B, the force pressing the operating part 22) can be reduced. As a result, the two connectors 10, 90 can be smoothly separated.

As depicted in FIG. 5A, the operating part 22 is located rearward of a center position Pc1 of the length of the beam part 21c in the front-back direction. Even with such a structure, the rear elastic part 24 can easily be lengthened by using the first curved part 24b.

As depicted in FIG. 5A, the rear elastic part 24 may further include a second curved part 24d. The second extending part 24c is connected to the front part of the second curved part 24d. The rear connecting part 21a is connected to the rear part of the second curved part 24d. The second curved part 24d may be curved in an arc shape, or may be bent at the center of the second curved part 24d. The rear connecting part 21a extends from the second curved part 24d toward the center C1 of the housing 20 in the left-right direction (toward the side surface 26b of the housing body 26).

As depicted in FIG. 5A, the second curved part 24d and the rear connecting part 21a are located rearward of the first curved part 24b. Therefore, in a side view of the housing 20 (when viewed in the direction of the arrow DL), a portion of the rear elastic part 24 does not overlap another portion of the rear elastic part 24. Therefore, as depicted in FIG. 5B, when the rear elastic part 24 is displaced, the plurality of curved parts 24b, 24d and the plurality of extended parts 24a, 24c do not come into mutual contact. As a result, the amount of displacement of the elastic locking part 21 in the left-right direction can be sufficiently ensured.

Furthermore, the rear elastic part 24 has the second curved part 24d, so the length of the rear elastic part 24 can easily be ensured. As a result, the operating force F required to displace the operating part 22 (see FIGS. 5A and 5B, the force pressing the operating part 22) can be further reduced.

FIG. 5B depicts the state of the beam part 21c when the operating part 22 is pressed. When the operating part 22 is pressed, the first extending part 24a moves in the direction of the arrow D1 (see FIG. 5A), and the position of the first curved part 24b and the second extending part 24c move in the direction of the arrow D2 (see FIG. 5A). In other words, the first extending part 24a is inclined toward the side surface 26b, centered on the first curved part 24b. Additionally, the position of the first curved part 24b and the second extending part 24c move rearward centered on the second curved part 24d.

In the initial state (state in which the beam part 21c is not elastically deformed), the end part 24e of the first curved part 24b (the end part closer to the side surface 26b, see FIG. 5A) is located closer to the center C1 of the housing 20 in the left-right direction than the inner surface 23c of the front elastic part 23 (surface facing the side surface 26b, see FIG. 5A). An end part 24f (end opposite side surface 26b) of the second curved part 24d is positioned outboard in the left-right direction relative to the side surface 23b (surface facing the opposite side surface 26b) of the front elastic part 23. This structure ensures that the rear elastic part 24 has sufficient length.

The thickness T1 (see FIG. 8B) of the first extending part 24a does not have to be uniform. The thickness T1 of the first extending part 24a may be gradually narrowed from a base part of the first extending part 24a closer to the operating part 22 toward the first curved part 24b. Thereby, the rear elastic part 24 can be allowed to elastically deform more easily.

As depicted in FIG. 5A, the operating part 22 is located rearward of a center position Pc1 of the beam part 21c in the front-back direction. The center of the operating part 22 in the front-back direction may be located rearward of the center position Pc1 of the beam part 21c, or the entire operating part 22 may be located rearward of the center position Pc1. Providing the operating part 22 in this manner makes it easier to ensure the length of the front elastic part 23 in the front-back direction. As a result, the movable range of the engaging part 23a can be easily ensured.

The engaging part 23a is shifted rearward with respect to a center position Pc2 (see FIG. 5A) of the front elastic part 23 in the front-back direction. Thereby, a movable range of the engaging part 23a can be ensured when the operating part 22 is pressed.

As depicted in FIG. 5B, the beam part 21c has a contact part 22c. The contact part 22c is a part that comes into contact with the side surface 26b when the operating part 22 moves toward the side surface 26b of the housing body 26.

As depicted in FIG. 4 and FIG. 5A, the side surface 26b of the housing body 26 may have a first portion 26e that faces the tip end 22e of the contact part 22c in the left-right direction, and a second portion 26f that faces the first curved part 24b in the left-right direction. Furthermore, the first portion 26e may protrude further toward the contact part 22c (outward in the left-right direction) than the second portion 26f. In other words, the second portion 26f may be recessed more than the first portion 26e. With this structure, the first curved part 24b can be effectively prevented from contacting the side surface 26b when the operating part 22 is pressed.

As depicted in FIG. 5A, the first portion 26e (protruding part) extends forward from a position facing the tip end 22e of the contact part 22c. The first portion 26e has a portion facing the front elastic part 23. With this structure, even if the force pressing on the operating part 22 is excessive and the contact part 22c contacts the first portion 26e and crumples, the first portion 26e contacts the inner surface 23c of the front elastic part 23, and as a result, the first curved part 24b is prevented from contacting the second portion 26f.

As depicted in FIG. 5A, the contact part 22c may be a protruding part that protrudes from the operating part 22 toward a side surface 26b of the housing body 26. The contact part 22c protrudes further toward the side surface 26b than the inner surface 23c of the front elastic part 23. When the operating part 22 is pressed, the tip end 22e of the protruding part comes into contact with the side surface 26b.

As depicted by the dashed line region R1 in FIG. 4, the thickness (width in the vertical direction) of the contact part 22c may be smaller than the thickness (width in the vertical direction) of the operating part 22. With this structure, the volume of the operating part 22 can be prevented from becoming excessively large, and as a result, the operating part 22 can easily be molded from resin.

As depicted in FIG. 5A, the contact part 22c has an inclined surface 22f that extends obliquely from the tip end 22e toward the first extending part 24a. This ensures the strength of the contact part 22c.

In the example depicted in the figure, a first portion 26e and a second portion 26f are formed on a side surface 26b of the housing body 26, and a contact part 22c protrudes from the operating part 22. As a result, in the initial state (state in which the beam part 21c is not elastically deformed), the distance L1 (see FIG. 8B) between the contact part 22c and the side surface 26b is smaller than the distance L2 (see FIG. 8B) between the end part 24e of the first curved part 24b and the side surface 26b.

With this structure, when the operating part 22 is pressed, the contact part 22c comes into contact with the side surface 26b of the housing body 26 before the first curved part 24b. The first curved part 24b does not come into contact with other portions of the housing 20. Thereby, elastic deformation of the rear elastic part 24 can be prevented from being unintentionally restricted, even if a large operating force F (see FIG. 5A and FIG. 5B) acts on the operating part 22.

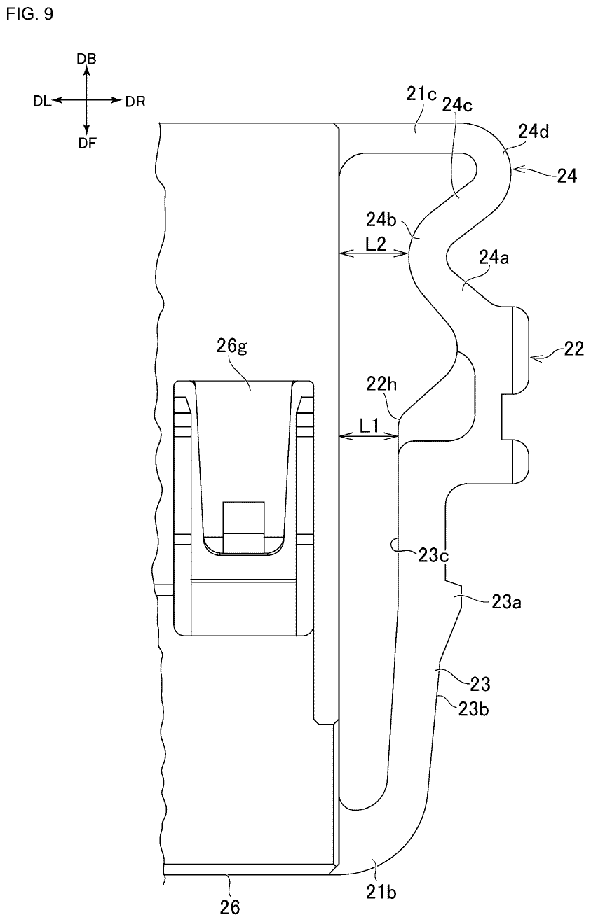

Note that the structure for preventing the first curved part 24b from contacting the side surface 26b of the housing body 26 is not limited to the example described above. For example, as depicted in FIG. 9, the first portion 26e might not be formed on the side surface 26b of the housing body 26. Moreover, the elastic locking part 21 depicted in FIG. 9 has a contact part 22h. The contact part 22h does not protrude from the operating part 22. With such a structure, the distance L1 (see FIG. 9) between the contact part 22h and the side surface 26b may be smaller than the distance L2 (see FIG. 9) between the end part 24e of the first curved part 24b and the side surface 26b. In other words, any configuration is acceptable so long as the distances L1 and L2 can maintain a relationship of L1<L2. Furthermore, the contact part 22h may be formed on the inner surface 23c of the front elastic part 23, rather than on the operating part 22. Note that in FIG. 9, the same sites as those previously described are denoted by the same reference numerals.

As described above, the connector 10 has a housing 20, and the mating connector 90 can be mated thereto from the front side. The housing 20 has a housing body 26 that stores a plurality of terminals 11 arranged in the left-right direction, and an elastic locking part 21 that is connected to the housing body 26 and is for engaging with a mating connector 90. The elastic locking part 21 has a rear connecting part 21a connected to the housing body 26, a front connecting part 21b connected to the housing body 26, and a beam part 21c connecting the rear connecting part 21a and the front connecting part 21b. The beam part 21c has a front elastic part 23 on which an engaging part 23a for engaging with the mating connector 90 is formed, and a rear elastic part 24 formed rearward of the front elastic part 23. The front elastic part 23 and the rear elastic part 24 are elastically deformable so that the engaging part 23a moves toward the housing body 26. The rear elastic part 24 has a first extending part 24a, a first curved part 24b, and a second extending part 24c. The first extending part 24a extends from the front part of the first curved part 24b in a direction away from the housing body 26, and the second extending part 24c extends from the rear part of the first curved part 24b in a direction away from the housing body 26.

With this connector 10, the rear elastic part 24 has the first curved part 24b, so the rear elastic part 24 can easily be made longer. As a result, the operating force F required to displace the operating part 22 (see FIGS. 5A, the force pressing the operating part 22) can be reduced. As a result, the two connectors 10, 90 can be smoothly separated.

It should be noted that the connector proposed in the present disclosure is not limited to the connector 10 described above.

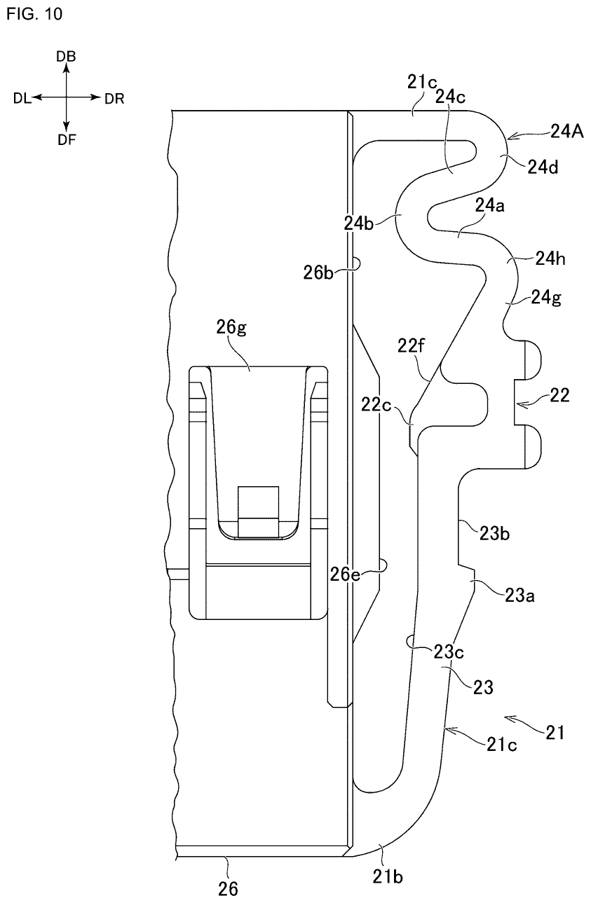

FIG. 10 depicts yet another modified example of the connector disclosed in the present disclosure. As depicted in the figure, the rear elastic part 24A may have a third extending part 24g. The third extending part 24g extends obliquely forward from the end part of the first extending part 24a (end part located on the outside in the left-right direction) toward the center C1 of the housing 20 in the left-right direction (toward the side surface 26b of the housing body 26). A third curved part 24h may be formed between the third extending part 24g and the first extending part 24a. Note that in FIG. 10, the same sites as those previously described are denoted by the same reference numerals.

Furthermore, in the connector 10, the connecting parts 21a, 21b of the elastic locking part 21 are connected to the side surface 26b of the housing body 26. However, the connecting parts 21a and 21b of the elastic locking part 21 may be connected to other portions of the housing body 26. For example, the connecting parts 21a and 21b of the elastic locking part 21 may be connected to the upper surface of the housing body 26 or to the lower surface of the housing body 26. In this case, the number of elastic locking parts 21 may be one. Furthermore, the housing 20 may have the elastic locking part 21 only on one of the right part or the left part.

Furthermore, in the connector 10, the elastic locking part 21 and the beam part 21c are located outside the connector body 26 in the left-right direction, but the positions of the elastic locking part 21 and the beam part 21c are not limited to this case. The lock part 21 and the beam part 21c may be located above the connector body 26. In this case, the first portion 26e and the second portion 26f of the connector body 26 may be formed on the upper surface (outer surface) 26h of the connector body 26. As yet another example, the connector body 26, the elastic locking part 21, and the beam part 21c may be located below the connector body 26. In this case, the first portion 26e and the second portion 26f may be formed on the lower surface (outer surface) of the connector body 26. Furthermore, in this case, the mating connector 90 is not mounted on the circuit board B, and the mating connector 90 and the connector 10 may be connectors that connect two cables to each other.

Furthermore, the connector 10 has a plurality of terminals 11 which are arranged in the left-right direction. However, the number of terminals 11 in the connector 10 may be one.

Moreover, the rear elastic part 24 does not necessarily have to have the second curved part 24d.

1. A connector having a housing, and that can be fitted from the front side to a mating connector,
the housing comprising:
a housing body that stores terminals; and
an elastic locking part connected to the housing body, and for engaging with the mating connector;
the elastic locking part comprising:
a rear connecting part connected to the housing body;
a front connecting part connected to the housing body; and
a beam part connecting the rear connecting part and the front connecting part;
the beam part comprising:
a front elastic part having an engaging part for engaging with the mating connector formed therein; and
a rear elastic part formed toward the rear of the front elastic part; wherein
the front elastic part and the rear elastic part are elastically deformable so that the engaging part moves toward the housing body;
the rear elastic part has a first extending part, a first curved part, and a second extending part;
the first extending part extends from a front part of the first curved part in a direction away from the housing body; and
the second extending part extends from a rear part of the first curved part in a direction away from the housing body.

2. The connector according to claim 1, wherein
the rear connecting part extends from a first end part of the rear connecting part connected to the housing body in a direction away from the housing body; and
the rear elastic part has a second curved part that connects a second end part of the rear connecting part and a second end part of the second extending part.

3. The connector according to claim 1, wherein
the rear connecting part is located rearward of the first extending part, the first curved part, and the second extending part.

4. The connector according to claim 1, wherein
the beam part has an operating part located between the front elastic part and the rear elastic part.

5. The connector according to claim 1, wherein
the elastic locking part has a contact part that contacts with an outer surface of the housing body when the engaging part moves toward the housing body; and
a distance between the contact part and the outer surface of the housing body is smaller than a distance between the first curved part and the outer surface of the housing body.

6. The connector according to claim 5, wherein
the outer surface of the housing body has a first portion facing the contact part, and a second portion facing the first curved part, and the first portion bulges toward the contact part more than the second portion.

7. The connector according to claim 5, wherein
the contact part protrudes from the operating part toward the outer surface of the housing body.

8. The connector according to claim 1, wherein
the beam part is located outside in the left-right direction with regard to the side surface of the housing body.

9. The connector according to claim 5, wherein
the beam part is located on an outer side in a left-right direction with regard to a side surface of the housing body; and
the contact part of the elastic locking part contacts a side surface of the housing body when the engaging part moves toward the housing body.

10. A connector assembly comprising:
the connector according to claim 9, and the mating connector.
